(19) United States
(12) Patent Application Publication
(10) Pub. No.: US 2005/0188671 A1
(43) Pub. Date: Sep. 1, 2005

(54) Adjustable tine leaf rake

(76) Inventors: Brian J. Conaway, Columbus, OH (US); Terry M. Birchler, New Albany, OH (US); Bryan Martin Shova, Columbus, OH (US); Donald James Staufenberg, Dublin, OH (US); Joshua Michael Broehl, Worthington, OH (US)

Correspondence Address: Porter, Wright, Morris & Arthur LLP;ATTN: Intellectual Property Department, 28th Floor, 41 South High Street, Columbus, OH, 43215-6194, US

(21) Appl. No.: 10/789,880

(22) Filed: Feb. 27, 2004

(51) Int. Cl. A01D 7/00

(52) U.S. Cl. 56/400.18

(57) ABSTRACT

A rake including a head, an elongate handle extending from the head, and a plurality of parallel, spaced-apart, flexible tines extending from the head opposite the handle. A brace is movable along the tines between first and second positions and limits a range of motion of the tines to change the effective length and thus the effective stiffness of the flexible tines. A locking device releasably secures the brace to the head in the first and second positions and preferably at locations between the first and second positions. Spacing between the tines remains unchanged as the brace moves between the first and second positions. The handle extends past the head to the tines improving stiffness of the head so that the rake is lightweight with a low profile.

### CROSS-REFERENCE TO RELATED APPLICATIONS

Not Applicable.

### STATEMENT REGARDING FEDERALLY SPONSORED RESEARCH

Not Applicable

### REFERENCE TO MICROFICHE APPENDIX

Not Applicable

### FIELD OF THE INVENTION

The present invention generally relates to rakes and, more particularly, to lawn rakes having resiliently flexible tines.

### BACKGROUND OF THE INVENTION

Rakes are typically suitable for a particular purpose depending on the length, spacing and/or flexibility of its tines or teeth. For example, it is desirable to have a leaf rake with relatively flexible teeth to provide light raking when removing leaves or other yard debris from flower beds or young grassy areas to avoid injuring flowers, young grass, and the like. Additionally, it is desirable to have a leaf rake with somewhat stiffer teeth to provide medium raking when removing dry leaves or other yard debris from lawns. Furthermore, it is desirable to have a leaf rake with relatively stiff teeth to provide heavy raking when removing wet leaves and other yard debris from lawns. This requires a homeowner to have several different types of rakes just to remove leaves in additional to the different types of rakes required to perform other tasks.

Prior attempts have been made to reduce the number of rakes needed to perform various tasks. For example, U.S. Pat. Nos. 1,785,320, 1,904,843, and 4,150,528 disclose rakes having teeth with adjustable lengths, the disclosures of which is expressly incorporated herein in its entirety by reference. The teeth of the '320 patent are secured to a plate and move in unison relative to a header of the rake to adjust the active length of the teeth. The length is adjusted to change the effective flexibility of the teeth so that the rake can be used in light duty applications in a flower bed or heavy duty application like raking gravel. The small length of the teeth when the teeth are relatively stiff, however, is not desirable for applications like raking wet leaves on a lawn.

U.S. Pat. No. 5,626,009 discloses a rake having tines with adjustable spacing, the disclosure of which is expressly incorporated herein in its entirety by reference. A sliding head is moved along the tines adjust the spacing between the tines. The spacing is adjusted so that the rake can be used to rake large items like leaves or small items like gravel or dirt. The reduced spacing between the tines when the tines are relatively stiff, however, is not desirable for applications like raking wet leaves on a lawn.

Thus, while these prior attempts to provide multi-purpose rakes have provided adjustable rakes which are adequate to rake various kinds of items or materials, no adjustable rake has been provided which adequately rakes leaves under all kinds of conditions regardless of whether they are wet or dry. Accordingly, there is a need in the art for an improved leaf rake.

### SUMMARY OF THE INVENTION

The present invention provides a rake which overcomes at least some of the above-noted problems of the related art. According to the present invention, a rake comprises, in combination, a head, an elongate handle extending from the head, and a plurality of parallel, spaced-apart, flexible tines extending from the head opposite the handle. A brace is movable along the tines between first and second positions to change the effective stiffness of the flexible tines. A locking device releasably secures the brace to the head in the first and second positions. Spacing between the tines remains unchanged as the brace moves between the first and second positions.

According to another aspect of the present invention, a rake comprises, in combination a head, an elongate handle extending from the head, and a plurality of spaced-apart, flexible tines extending from the head opposite the handle. The handle extends to the tines.

According to yet another aspect of the present invention, a rake comprises, in combination, a head, an elongate handle extending from the head, and a plurality of parallel, spaced-apart, flexible tines extending from the head opposite the handle. A brace is movable along the tines between first and second positions to change the effective stiffness of the flexible tines. A locking device releasably secures the brace to the head in the first and second positions and at locations between the first and second positions. Spacing between the tines remains unchanged as the brace moves between the first and second positions. The handle extends to the tines.

From the foregoing disclosure and the following more detailed description of various preferred embodiments it will be apparent to those skilled in the art that the present invention provides a significant advance in the technology of adjustable rakes. Particularly significant in this regard is the potential the invention affords for providing a high quality, reliable, simple, and easily adjusted assembly with improved operational performance. Additional features and advantages of various preferred embodiments will be better understood in view of the detailed description provided below.

### BRIEF DESCRIPTION OF THE DRAWINGS

These and further features of the present invention will be apparent with reference to the following description and drawings, wherein:

FIG. 1 is a front elevational view of an adjustable-tine leaf rake according to a preferred embodiment of the present invention;

FIG. 2 is a front-bottom-left perspective view of the rake of FIG. 1;

FIG. 3 is an enlarged, fragmented view showing a front view of an interface between a movable brace and a plurality of flexible tines;

FIG. 4 is a rear-bottom-right perspective view of the rake of FIGS. 1 to 3;

FIG. 5 is an enlarged fragmented view showing a rear view of the interface between the movable brace and the plurality of flexible tines;

FIG. 6 is an enlarged fragmented view of a head of the rake of FIGS. 1 to 5 showing a locking device interface; and

FIG. 7 is an enlarged fragmented view of the movable brace of the rake of FIGS. 1 to 5 showing a locking device interface.

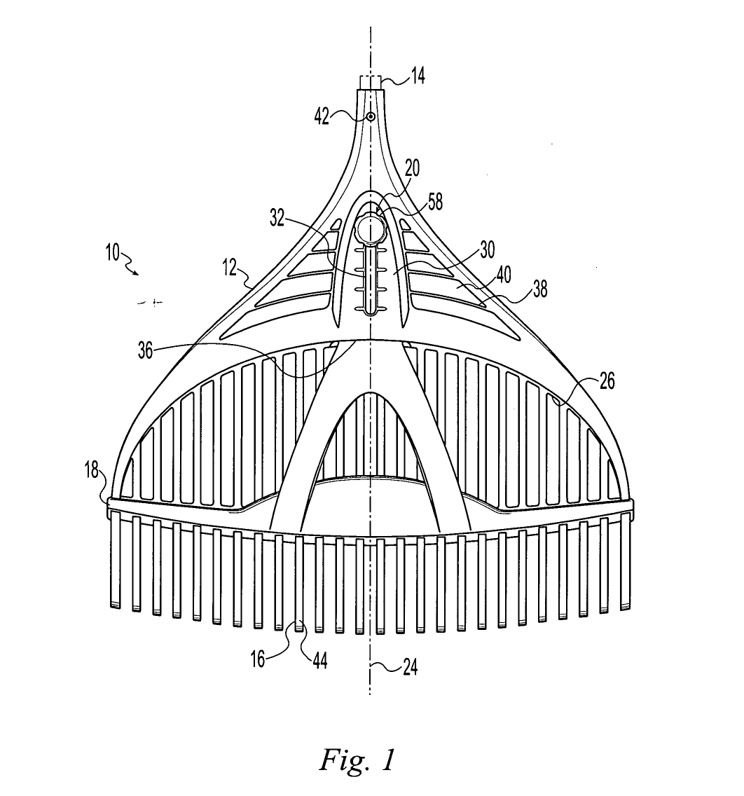

It should be understood that the appended drawings are not necessarily to scale, presenting a somewhat simplified representation of various preferred features illustrative of the basic principles of the invention. The specific design features of the rakes as disclosed herein, including, for example, specific dimensions, orientations, and shapes of the various components will be determined in part by the particular intended application and use environment. Certain features of the illustrated embodiments have been enlarged or distorted relative to others to facilitate visualization and clear understanding. In particular, thin features may be thickened, for example, for clarity or illustration. All references to direction and position, unless otherwise indicated, refer to the orientation of the rake illustrated in the drawings. In general, up or upward refers to an upward direction in FIG. 1 and down or downward refers to a downward direction in FIG. 1. Also in general, fore or forward refers to a direction toward the free end of the tines of the rake and a downward direction in FIG. 1. Furthermore in general, aft, rear or rearward refers to a direction away from the free end of the tines of the rake and an upward direction in FIG. 1.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved rakes disclosed herein. The following detailed discussion of various alternative and preferred embodiments will illustrate the general principles of the invention with reference to a leaf rake for applications in residential or commercial environments. Other embodiments suitable for other applications will be apparent to those skilled in the art given the benefit of this disclosure.

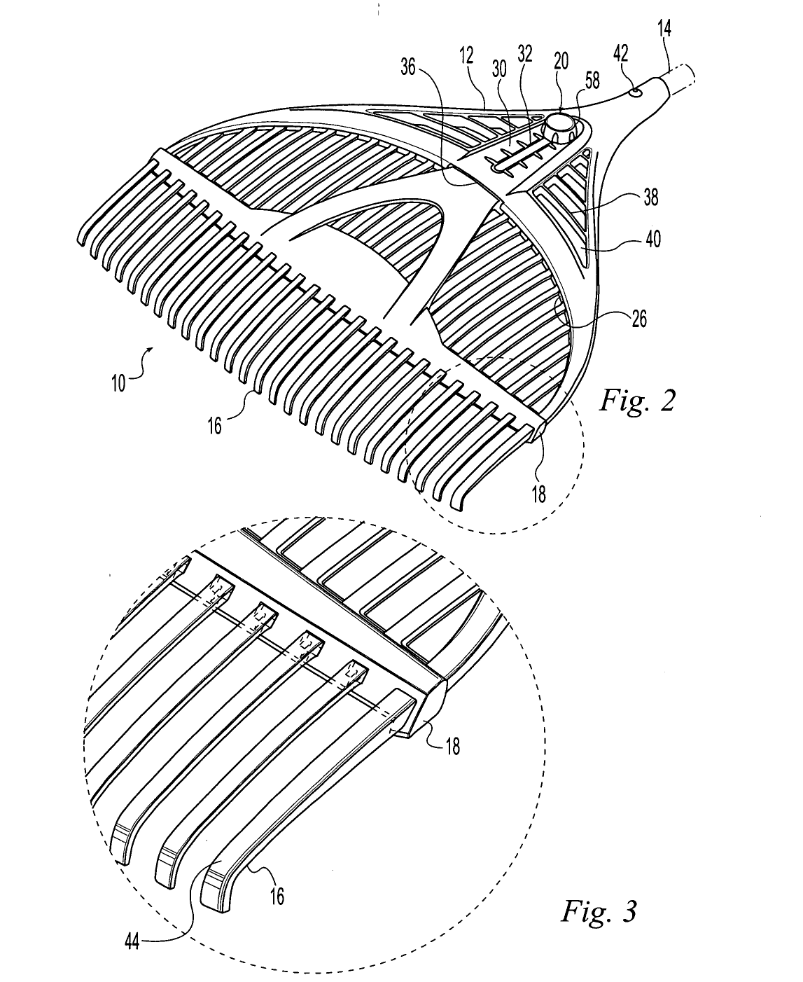

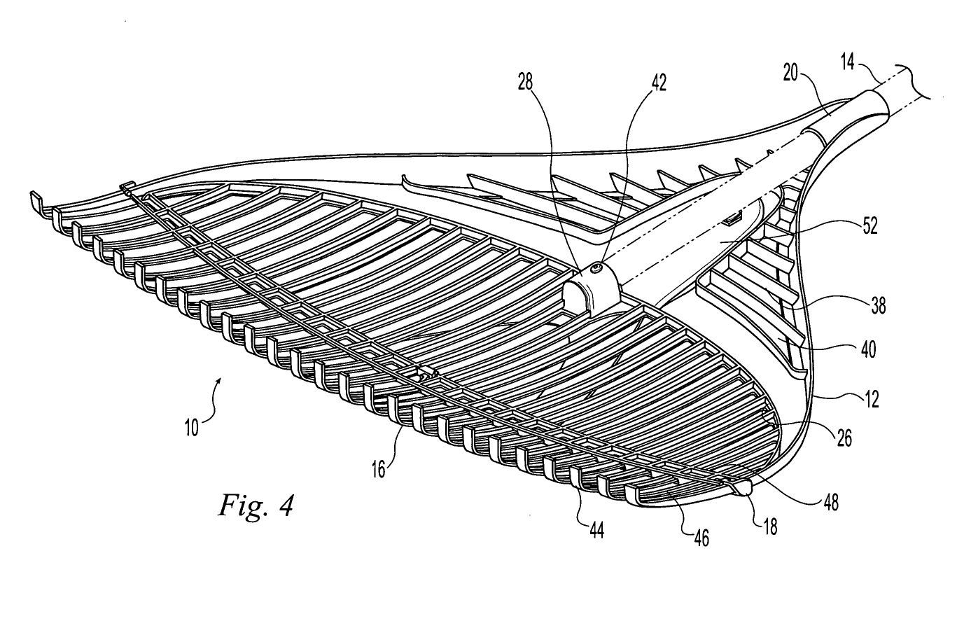

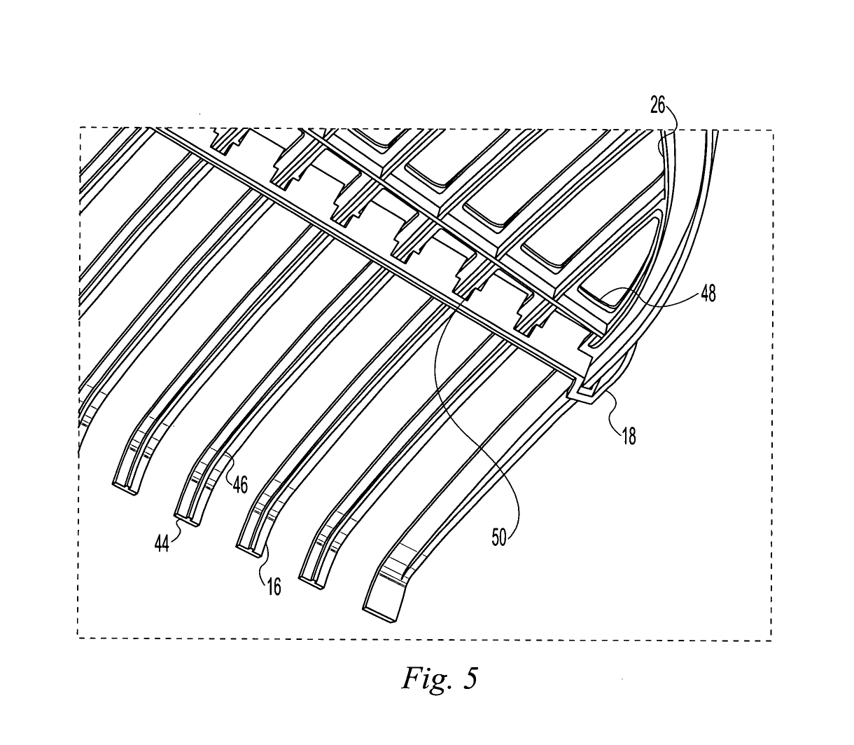

Referring now to the drawings, FIGS. 1 to 5 illustrate an adjustable-tine leaf rake 10 according to a preferred embodiment of the present invention which can be easily adjusted between a relatively flexible configuration for raking dry leaves, a relatively stiff configuration for raking wet leaves, and a plurality of configurations therebetween. The illustrated leaf rake 10 includes a head 12, an elongate handle 14 extending from the head 12, a plurality of flexible tines 16 extending from the head 12 opposite the handle 14, a movable brace 18 movable along the tines 16 to effective change stiffness of the flexible tines 16, and a locking device 20 releasably securing the movable brace 18 to the head 12 in desired positions along the tines 16.

The illustrated head 12 has a cylindrically shaped support 22 at its upper end and laterally expands in an arcuate manner. The support 22 has a vertically extending passage therethrough that forms a central axis 24 for the rake 10. The lower end of the head 12 forms a concave edge 26 from which the flexible tines 16 extend. Located below the concave edge 26 an at the tines 16 is a vertically extending socket 28 having an open upper end and a closed lower end. The socket 28 is spaced below the support 22 and coaxial therewith. The support 22 and the socket 28 are sized and shaped to cooperate with and receive the handle 14 as described in more detail hereinbelow.

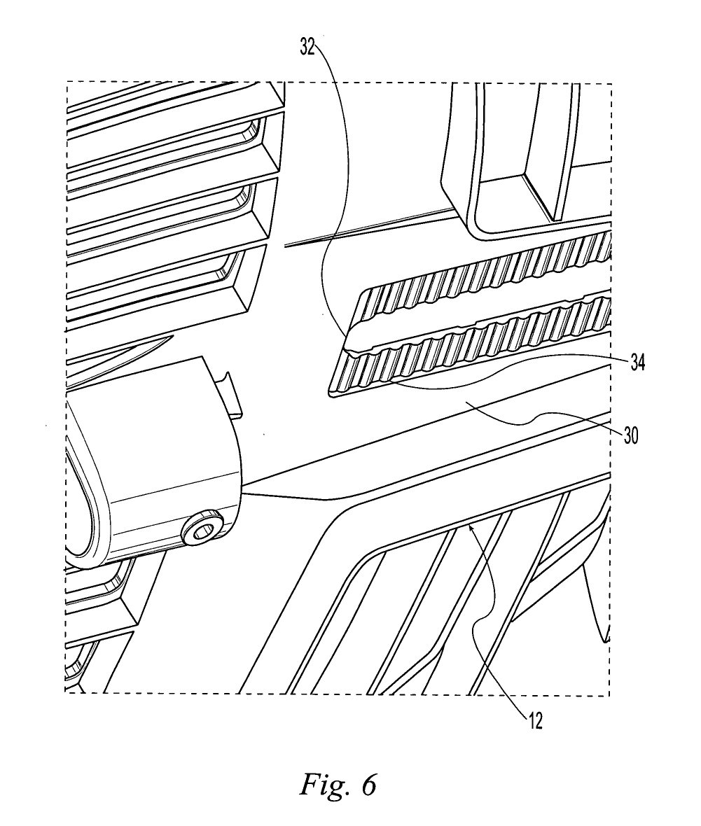

A central portion of the illustrated head 12 forms a generally planar portion or surface 30 having a vertically extending slot 32 for cooperation with the locking device 20 as described in more detail hereinbelow. As best shown in FIG. 6, a plurality of laterally extending, parallel and vertically spaced-apart protrusions 34 are provided on each of the lateral sides of the slot 32 of the illustrated head. The illustrated protrusions 34 have generally rounded or arcuate free or outer ends so that they are generally semi-circular in cross-section. The illustrated protrusions 34 are located at a rearward side of the head 12 and form spaced apart grooves therebetween for interlocking with the movable brace 18 as described in more detail hereinbelow. It is noted that the illustrated protrusions 34 are located in a recess so that they are located below the outer surface of the planar portion 30.

The central portion of the lower edge 26, at the planar surface 30, is also provided with a slot or opening 36 sized and shaped to cooperate with the movable brace 18 as described in more detail hereinbelow. The illustrated head 12 also includes a plurality of ribs 38 for stiffening the head 12 so that it can be of light weight and low profile construction. The illustrated ribs 38 are located on each lateral side of the planar surface 30 of the central portion and are generally horizontal, vertically spaced apart and laterally extending. Openings 40 are preferably provided between the ribs 38 to reduce the weight of the head.

The head 12 is preferably molded of a suitable plastic material so that it is of unitary construction. It is noted, however, that the head 12 can alternatively be formed of other suitable materials and/or can be formed of separate components secured together.

The handle 14 is suitable sized and shaped for a user to manually operate the rake 10. The handle 14 can be shaped in any desired manner such as for example, straight or curved in an ergonomic manner. The handle 14 is preferably elongate and rigid. The illustrated handle 14 is circular in cross section but any other suitable shape alternatively can be utilized. The handle 14 can be formed of any suitable material such as, for example, wood, plastic, fiberglass, or metal.

The illustrated handle 14 downwardly extends through the support 22 and into the socket 28 along the central axis 24. The handle 14 is preferably secured to the head 12 in a suitable manner such as the illustrated mechanical fasteners 42 at the support 22 and the socket 28. It is noted that other suitable means for fastening can alternatively be utilized such as, for example, welding, adhesives, locks and clips. The handle 14 preferably extends entirely past the head 12 to the tines 16 so that the handle 14 provides rigidity to the head 12. Constructed in this manner, the head 12 can be advantageously formed in a lightweight and low profile manner.

The plurality flexible tines 16 downwardly extend from the concave lower edge 26 of the head 12 in a cantilever manner so that they have free lower ends and secured upper ends. The plurality of tines 16 are elongate, parallel and laterally spaced apart. The illustrated tines 16 each have a generally planar front surface 44 and a rearwardly disposed rib 46 that extends along the length of the tines 16 so that the tines 16 are generally T-shaped in cross section. The ribs 46 of the outer most tines 16, however, are located at the outer lateral edge of the tines 16 so that the tines are generally L-shaped in cross-section. It is noted that the tines 16 can alternatively have any suitable shape within the scope of the present invention. The rake 10 can be provided with any suitable quantity of the tines 16. The illustrated tines are provided with a laterally extending fixed brace spaced below the edge 26 and along the length of the tines 16. It is noted that the fixed brace 48 can be eliminated in embodiments where the head 12 and/or the tines 16 have desired stiffness/flexibility.

The tines 16 are preferably molded of plastic but alternatively can be formed of any other suitable material such as, for example, metal. The tines 16 are also preferably molded of unitary construction with the head 12 but alternatively can be separate and secured to the head 12. Therefore, for example, the tines 16 can be plastic and molded unitary with the plastic head 12 or the tines 16 can be metal and secured to the plastic head 12.

The movable brace 18 has a lower portion sized and shaped to interface with the tines 16 and an upper portion sized and shaped to interface with the head 12 and the locking device 20 as described in more detail hereinbelow. The lower portion laterally extends generally perpendicular to the tines 16 and is provided with a plurality of openings 50 therein for passage of the tines 16 through the lower portion. The illustrated movable brace 18 includes a separate one of the openings 50 for each of the tines 16. The openings 50 are preferably sized and shaped to cooperate with the tines 16. The illustrated openings 50 are generally T-shaped.

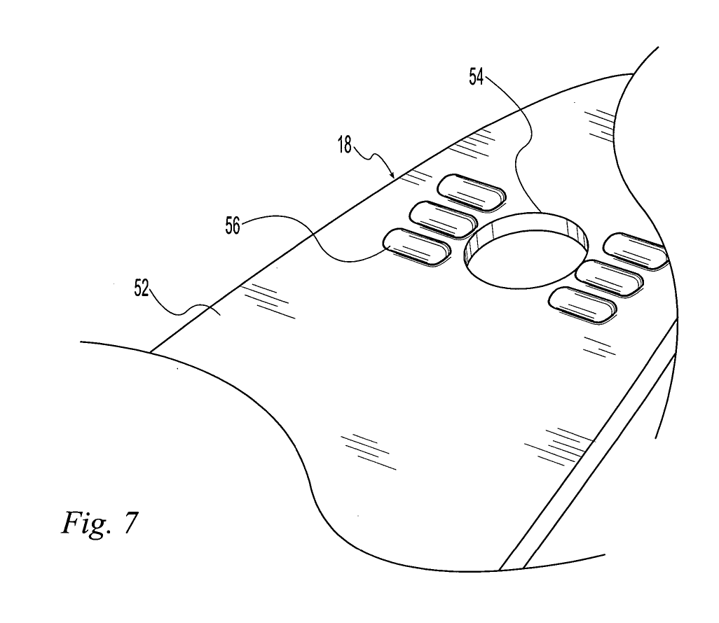

The upper portion extends upwardly from the lower portion of the movable brace 18 and has a generally planar portion 52 which extends through the opening 36 in the head 12 and is disposed between the planar portion 30 of the head 12 and the handle 14. The illustrated planar portion 52 is provided with an opening 54 for cooperation with the locking device 20. As best shown in FIG. 7, a plurality of laterally extending, parallel and vertically spaced-apart protrusions 56 are provided on each of the lateral sides of the opening 54 of the illustrated movable brace 18. The illustrated protrusions 56 are located at a forward side of the movable brace 18 and form spaced apart grooves for interlocking with the protrusions 34 of the head 12. The illustrated protrusions 56 have generally rounded or arcuate free or outer ends so that they are generally semi-circular in cross-section. The interlocking protrusions 34, 56 cooperate to lock the movable brace 18 and the head 12 together and to hold the movable brace 18 in a desired position along the tines 16.

The locking device 20 is provided to selectively and releasably secure the movable brace 18 in a desired position by securely engaging the protrusions 34, 56. The locking device 20 can be of any suitable type within the scope of the present invention. The illustrated locking device 20 includes a knob 58 located forward of the head slot 32 and extends through the head slot 32 and the brace opening 54 to a cam lock. Constructed in this manner, rotation of the knob 58 brings the protrusions 34, 56 into and out of engagement to lock and unlock the movable brace 18 to the head 12. Preferably, the locking device 20 is locked and unlocked by about ninety degree rotation of the knob 58. It is noted that any suitable type of locking device can be utilized within the scope of the present invention. It is also noted that the locking device can alternatively lock the movable brace 18 directly to the tines 16.

In use, the movable brace 18 can be selectively moved between a first or full up position, near the fixed brace 48, and a second or full down position, near the free end of the tines 16, to adjust the effective length of the tines 16 to limit the range of motion of the tines 16 and therefore the effective stiffness an/or flexibility of the tines 16. The movable brace 18 ties the tines 16 together so that movement of the movable brace 18 along the tines 16 changes the effective length of the tines 16. It should be appreciated that the tines 16 become effectively more stiff or less flexible as the movable brace 18 is located closer to the lower or free ends of the tines 16 and become effectively more flexible or less stiff as the movable brace 18 is located closed to the upper or secured ends of the tines 16. As the movable brace 18 moves along the length of the tines 16, the lateral-spacing of the tines 16 is not changed so that the tines 16 remain in a desired or optimized spaced for raking leaves. To make an adjustment, the user turns the knob 58 to unlock the locking device 20 such that the protrusions 34, 56 are not interlocked. Once unlocked, the user slides the movable brace 18 to the desired new position and the user turns the knob 58 to again lock the locking device 20 and interlock the protrusions 34, 56. The illustrated movable brace 18 can be locked at a plurality of positions between the full up and down positions. It is noted that the number of “lockable” positions can be increased or decreased depending on the construction of the protrusions 34, 56. It is also noted that the movable brace 18 can be constructed with infinite adjustment if desired.

From the foregoing disclosure and detailed description of certain preferred embodiments, it will be apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

1. A rake comprising, in combination:
a head;
an elongate handle extending from the head;
a plurality of parallel, spaced-apart, flexible tines extending from the head opposite the handle;
a brace movable along the tines between first and second positions to change effective stiffness of the flexible tines;
a locking device selectively operable to releasably secure the brace to the head in each of the first and second positions to prevent movement of the brace relative to the tines;
wherein the brace moves relative to the handle as the brace moves between the first and second positions; and
wherein spacing between the tines remains unchanged as the brace moves between the first and second positions.

2. The rake according to claim 1, wherein each of the tines extend through separate openings formed in the brace.

3. The rake according to claim 2, wherein each of the tines has a rearwardly extending rib such that the tines are generally T-shaped in cross-section.

4. The rake according to claim 3, wherein each of the openings are generally T-shaped in cross-section.

5. The rake according to claim 1, wherein the head and tines are unitarily molded of plastic.

6. The rake according to claim 1, wherein the head is molded of plastic and the tines are formed of metal.

7. The rake according to claim 1, wherein the locking device includes interlocking protrusions and grooves formed in the head and the brace.

8. The rake according to claim 1, wherein the locking device is selectively operable to releasably secure the brace to the head at locations between the first and second positions to prevent movement of the brace relative to the tines.

9. The rake according to claim 1, wherein the locking device comprises a knob and rotation of the knob locks and unlocks the locking device.

10. The rake according to claim 1, wherein the tines are unremovable from the head.

11. The rake according to claim 1, wherein the handle extends to the tines.

12. The rake according to claim 11, wherein the head includes a socket at the tines and a support forming a passage extending through the support and spaced apart from the socket, and wherein the handle extends through the passage and into the socket.

13. (canceled)

14. (canceled)

15. The rake according to claim 12, wherein the head, socket and support are unitarily molded of plastic.

16. The rake according to claim 12, wherein the support is generally cylindrical shaped.

17. (canceled)

18. (canceled)

19. (canceled)

20. A rake comprising, in combination:
a head;
an elongate handle extending from the head;
a plurality of parallel, spaced-apart, flexible tines extending from the head opposite the handle;
a brace movable along the tines between first and second positions to change effective stiffness of the flexible tines; and
a locking device selectively operable to releasably secure the brace to the head in each of the first and second positions and at locations between the first and second positions to prevent movement of the brace relative to the tines;
wherein the handle is secured to the head to prevent relative movement therebetween as the brace moves between the first and second positions; and
wherein spacing between the tines remains unchanged as the brace moves between the first and second positions.

21. The rake according to claim 20, wherein the brace moves relative to the handle as the brace moves between the first and second positions.

22. The rake according to claim 20, wherein the handle is directly secured to the head.

23. The rake according to claim 1, the handle is secured to the head to prevent relative movement therebetween as the brace moves between the first and second positions.

24. The rake according to claim 1, wherein the handle is directly secured to the head.
